(19) United States
(12) Patent Application Publication
(10) Pub. No.: US 2010/0043898 A1
(43) Pub. Date: Feb. 25, 2010

(54) Bridge Faucet with Side Spray Kit

(76) Inventor: EFRAIM ECKHAUS, West Haven, CT (US)

Correspondence Address: HARVEY LUNENFELD, 8 PATRICIAN DRIVE, E. NORTHPORT, NY, 11731, US

(21) Appl. No.: 12/426,953

(22) Filed: Apr. 20, 2009

Related U.S. Application Data
(63) Continuation-in-part of application No. 29/323,407, filed on Aug. 25, 2008, now Pat. No. D591400.
Application No. 29/323,407 is a continuation-in-part of application No. 29/323,410, filed on Aug. 25, 2008, now Pat. No. D592279.
Application No. 29/323,410 is a continuation-in-part of application No. 29/323,412, filed on Aug. 26, 2008, now Pat. No. D592280.
Application No. 29/323,412 is a continuation-in-part of application No. 29/323,414, filed on Aug. 26, 2008, now Pat. No. D591401.
Application No. 29/323,414 is a continuation-in-part of application No. 29/323,415, filed on Aug. 26, 2008, now Pat. No. D590920.
Application No. 29/323,415 is a continuation-in-part of application No. 29/323,416, filed on Aug. 26, 2008, now Pat. No. D591402.

(51) Int. Cl. F16K 31/00

(52) U.S. Cl. 137/625

(57) ABSTRACT

A bridge faucet with side spray kit of modular knockdown construction comprising removably replaceable components, including: opposing valve bodies having opposing valve body chambers, opposing conduits, substantially centrally disposed mixing body having mixing body chamber, valve body cartridge valves, mixing body diverter cartridge, spout, side spray kit, and mixing body cap, the opposing valve bodies matingly and releasably fastened to the opposing conduits, the opposing conduits matingly and releasably fastened to the substantially centrally disposed mixing body, the valve body cartridge valves adapted to matingly and removably fit into the valve body chambers, the mixing body diverter cartridge adapted to matingly and removably fit into the mixing body chamber, the side spray kit and mixing body cap selectively and alternatively matingly and removably fastened to the substantially centrally disposed mixing body, the mixing body diverter cartridge preventing water from flowing into the spout when the side spray kit is used.

This application is a continuation-in-part of U.S. patent application Ser. No. 29/323,407, filed Aug. 25, 2008, and this application is a continuation-in-part of U.S. patent application Ser. No. 29/323,410, filed Aug. 25, 2008, and this application is a continuation-in-part of U.S. patent application Ser. No. 29/323,412, filed Aug. 26, 2008, and this application is a continuation-in-part of U.S. patent application Ser. No. 29/323,414, filed Aug. 26, 2008, and this application is a continuation-in-part of U.S. patent application Ser. No. 29/323,415, filed Aug. 26, 2008, and this application is a continuation-in-part of U.S. patent application Ser. No. 29/323,416, filed Aug. 26, 2008, the full disclosures of which all are incorporated herein by reference. The above referenced documents are not admitted to be prior art with respect to the present invention by their mention herein.

### BACKGROUND OF THE INVENTION

1. Field of the Invention

The present invention relates generally to faucets and more particularly to bridge faucets.

2. Background Art

Bridge faucets and bridge faucets with side sprays have been known. Such bridge faucets and bridge faucets with side sprays typically have faucet bodies of one piece construction. A typical bridge faucet includes a one piece faucet body comprising opposing inlet pillars, a mixing chamber, and opposing conduit arms extending from the opposing inlet pillars to the mixing chamber. Valves for controlling water flow received within the opposing inlet pillars are integrally incorporated into the opposing inlet pillars. Water received from the valves within the opposing inlet pillars, which flows through the opposing conduit arms, is typically mixed within mixing chamber and fed to a spout for delivery. A diverter valve may be integrally incorporated into the mixing chamber or integrally mounted to one of the opposing inlet pillars for diverting water from the spout and into a side spray inlet, which feeds water to a side spray via a flexible hose, which is typically permanently affixed to the bridge faucet.

Such bridge faucets and bridge faucets with side sprays having one piece faucet bodies do not facilitate easy replacement and/or substitution of opposing inlet pillars, opposing conduit arms, mixing body, and other parts and/or components when desired or required and are typically expensive to construct and/or replace.

There is a need for a bridge faucet with side spray kit of modular construction. The bridge faucet with side spray kit should have removably replaceable opposing valve bodies, removably replaceable valve body valve cartridges, removably replaceable opposing conduit arms, a removably replaceable mixing body, a removably replaceable diverter valve, a removably replaceable spout, a removably replaceable side spray kit that allows the bridge faucet to be used, installed, and/or easily converted into a bridge faucet with or without a side spray kit.

The bridge faucet with side spray kit should be of modular construction and/or knockdown construction and be capable of being fabricated from a plurality of interchangeable parts that may be used to construct a large variety of bridge faucets with side spray kits, and in particular a large variety of bridge faucets with side spray kits of different ornamental designs.

The bridge faucet with side spray kit should be capable of being installed and used as a bridge faucet without a side spray, installed as a bridge faucet with a side spray, or capable of being converted from one to the other after installation and use.

The bridge faucet with side spray kit should be capable of being sold with different easily replaceable components or components that may be substituted, and allow consumers to construct the bridge faucet with side spray kit into a variety of ornamental bridge faucets with side spray kits having different geometries and configurations, and allow the different mounting configurations.

The bridge faucet with side spray kit should be capable of being installed and/or repaired simply, easily, and quickly. An assortment of replaceable components should be available for use with the bridge faucet with side spray kit, which should be capable of being quickly and easily removably installed and removably replaced to and from the bridge faucet with side spray kit. The bridge faucet with side spray kit should be durable, light weight, inexpensive, safe to use, attractive, sturdy, and of simple construction.

Different bridge faucets have heretofore been known. However, none of the bridge faucets adequately satisfies these aforementioned needs.
U.S. Pat. No. 6,467,104 (Shieh) discloses a faucet assembly having an attachable sprayer nozzle, in which a faucet device includes a faucet member having one or more ports for coupling to water reservoirs and a water outlet.

The faucet member includes a hole and a chamber communicating with each other. A hose has one end coupler for selectively securing to the hole of the faucet member, and a sprayer device coupled to another end. A valve device may be used for controlling the water to flow out through the sprayer device and the outlet of the faucet member. A lock cap may be selectively secured to the hole of the faucet member, when the coupler is disengaged from the faucet member.
U.S. Pat. No. 7,216,663 (Vu) discloses a diverting device for a bridge faucet with hand spray, having a faucet assembly that includes a diverter valve assembly mounted to an inlet of a cold-water pillar and is in fluid communication with a control valve disposed on a hot-water pillar. The diverter valve assembly selectively controls water flow through a spout and a hand spray. The faucet assembly includes a cold-water pillar and a hot-water pillar that are pivotally connected to a bridge that allows adjustment of a distance between the hot and cold-water pillars.
U.S. Pat. No. 7,096,879 (Yardley) discloses a pillar sink mixer with hand spray, in which a pillar sink mixer has a hot water faucet pillar, a cold water faucet pillar, a mixing chamber and a diverter valve to supply mixed water to a faucet nozzle or to a hand spray. The mixing chamber and diverter valve are positioned in a bridge above a mounting surface, and a passage, providing fluid communication with the hand spray device, being incorporated within the bridge and a faucet pillar.
U.S. Pat. No. 6,920,892 (Agresta, et al.) a side spray diverter valve with anti-siphoning and flow regulation of water diverted to a spray head. A ported valve plunger sliding in a sleeve admits water from an inlet to the spout in one position, while a lower O-ring seals a spray outlet. In another position, the sleeve has axially directed ports, which screen and trap particulates in the water over a predetermined size. The flow rate of screened water to the spray is regulated by the lower O-ring pressing against grooves in a wall of the sleeve.
U.S. Pat. No. 2,314,071 (Bucknell, et. al.) discloses a pressure control fitting for controlling the direction of flow of water to one of the outlets of a faucet and minimizing siphon action, which is shown having a spray head and actuating valve, and flexible conduit for feeding water to the spray head.
U.S. Pat. No. 4,793,375 (Marty) discloses a faucet valve cartridge for a dual handle faucet, which facilitates conversion between a lever-operated faucet and a knob-operated faucet utilizing identical components. The cartridge may be used to control either the hot-water supply or the cold-water supply to the faucet spout. The cartridge includes an integrally formed stop member and housing within which is rotatably disposed a valving member. The housing includes a pair of outlet ports and is open to the bottom to receive the valving member and a pair of cooperating valving plates which control fluid flow. Orientation of the valving plates within the housing controls the specific configuration of the valve cartridge. Preferably the valving plates are made of a ceramic material to reduce wear and facilitate rotation.

For the foregoing reasons, there is a need for a bridge faucet with side spray kit that is of modular construction. The bridge faucet with side spray kit should have removably replaceable opposing valve bodies, removably replaceable valve body valve cartridges, removably replaceable opposing conduit arms, a removably replaceable mixing body, a removably replaceable diverter valve, a removably replaceable spout, a removably replaceable side spray kit that allows the bridge faucet to be used, installed, and/or easily converted into a bridge faucet with or without a side spray kit.

The bridge faucet with side spray kit should be of modular construction and/or knockdown construction and be capable of being fabricated from a plurality of interchangeable parts that may be used to construct a large variety of bridge faucets with side spray kits, and in particular a large variety of bridge faucets with side spray kits of different ornamental designs.

The bridge faucet with side spray kit should be capable of being installed and used as a bridge faucet without a side spray, installed as a bridge faucet with a side spray, or capable of being converted from one to the other after installation and use.

The bridge faucet with side spray kit should be capable of being sold with different easily replaceable components or components that may be substituted, and allow consumers to construct the bridge faucet with side spray kit into a variety of ornamental bridge faucets with side spray kits having different geometries and configurations, and allow the different mounting configurations.

The bridge faucet with side spray kit should be capable of being installed and/or repaired simply, easily, and quickly. An assortment of replaceable components should be available for use with the bridge faucet with side spray kit, which should be capable of being quickly and easily removably installed and removably replaced to and from the bridge faucet with side spray kit. The bridge faucet with side spray kit should be durable, light weight, inexpensive, safe to use, attractive, sturdy, and of simple construction.

### SUMMARY

The present invention is directed to a bridge faucet with side spray kit of modular construction. The bridge faucet with side spray kit has removably replaceable opposing valve bodies, removably replaceable valve body valve cartridges, removably replaceable opposing conduit arms, a removably replaceable mixing body, a removably replaceable diverter valve, a removably replaceable spout, a removably replaceable side spray kit that allows the bridge faucet to be used, installed, and/or easily converted into a bridge faucet with or without a side spray kit.

The bridge faucet with side spray kit may be of modular construction and/or knockdown construction and is capable of being fabricated from a plurality of interchangeable parts that may be used to construct a large variety of bridge faucets with side spray kits, and in particular a large variety of bridge faucets with side spray kits of different ornamental designs.

The bridge faucet with side spray kit is capable of being installed and used as a bridge faucet without a side spray, installed as a bridge faucet with a side spray, and capable of being converted from one to the other after installation and use.

The bridge faucet with side spray kit is capable of being sold with different easily replaceable components or components that may be substituted, and allows consumers to construct the bridge faucet with side spray kit into a variety of ornamental bridge faucets with side spray kits having different geometries and configurations, and allows the different mounting configurations.

The bridge faucet with side spray kit is capable of being installed and/or repaired simply, easily, and quickly. An assortment of replaceable components will be available for use with the bridge faucet with side spray kit, which is capable of being quickly and easily removably installed and removably replaced to and from the bridge faucet with side spray kit. The bridge faucet with side spray kit is durable, light weight, inexpensive, safe to use, attractive, sturdy, and of simple construction.

A bridge faucet with side spray kit having features of the present invention comprises:
opposing valve bodies,
   each valve body of the opposing valve bodies having:
      a valve body chamber,
      a valve body inlet, a valve body outlet, and a valve body bore, each communicating with the valve body chamber,
         a valve body cartridge valve adapted to matingly and removably fit into the valve body chamber through the valve body bore and adapted to control flow of fluid between the valve body inlet and the valve body outlet;
opposing conduits,
   each conduit of the opposing conduits having:
      a conduit inlet end matingly and releasably fastened to one of the valve body outlets,
      a conduit outlet;
a substantially centrally disposed mixing body having:
   a mixing body chamber,
   opposing mixing body inlets communicating with the mixing body chamber,
      each mixing body inlet of the mixing body inlets matingly and releasably fastened to one of the conduit outlets,
   a mixing body spout outlet and a mixing body side spray outlet, each communicating with the mixing body chamber,
   a mixing body diverter cartridge adapted to matingly and removably fit into the mixing body chamber through the mixing body spout outlet and adapted to mix the fluid received within the mixing body chamber from the opposing valve bodies via the opposing conduits;
   a spout matingly and releasably fastened to the mixing body spout outlet,
   a side spray kit,
      the side spray kit having a side spray kit coupling adapted to matingly and releasably fasten to the mixing body side spray outlet,
      a flexible conduit having a flexible conduit inlet end and a flexible conduit outlet end,
         the flexible conduit inlet end coupled to the side spray kit coupling, a side spray valve,
         the side spray valve coupled to the flexible conduit outlet end and adapted to control flow of the fluid received from the substantially centrally disposed mixing body via the flexible conduit;
      the mixing body diverter cartridge adapted to divert the fluid received within the mixing body chamber from the opposing valve bodies via the opposing conduits and prevent the fluid from flowing into the spout when the side spray kit coupling is matingly and releasably fastened to the mixing body side spray outlet and when the side spray valve is turned on;
      a mixing body cap adapted to matingly and releasably fasten to the mixing body side spray outlet when the side spray kit coupling is removed from the mixing body side spray outlet.

### DRAWINGS

These and other features, aspects, and advantages of the present invention will become better understood with regard to the following description, appended claims, and accompanying drawings where:

FIG. 1 is a perspective view of a bridge faucet with side spray kit shown exploded, constructed in accordance with the present invention, and a partial cutaway view of a valve body of the present invention;

FIG. 2 is a perspective view of the bridge faucet of FIG. 1 with a mixing body cap of the present invention fastened to a mixing body of the present invention;

FIG. 3 is a front view of the bridge faucet of FIG. 1 with the mixing body cap fastened to the mixing body and the bridge faucet mounted to a counter top shown in cross section;

FIG. 4 is a cross section view of the mixing body of the bridge faucet of FIG. 1 with the mixing body cap fastened to the mixing body;

FIG. 5 is another cross section view of the mixing body of the bridge faucet of FIG. 1 with the mixing body cap fastened to the mixing body;

FIG. 6 is a bottom view of the bridge faucet of FIG. 1;

FIG. 7 is a perspective view of the bridge faucet of FIG. 1 and a side spray of the side spray kit with a coupling of the side spray kit fastened to the mixing body;

FIG. 8 is a front view of the bridge faucet of FIG. 1 showing the side spray with the coupling of the side spray kit fastened to the mixing body, and the bridge faucet mounted to the counter top shown in cross section;

FIG. 9 is a cross section view of the mixing body of the bridge faucet of FIG. 1 with the lower riser of the side spray kit fastened to the mixing body;

FIG. 10 is another cross section view of the mixing body of FIG. 9 with the coupling of the side spray kit fastened to the mixing body;

FIG. 11 is a partial front view of the side spray mounted to the counter top shown in cross section;

FIG. 12 is a perspective view of an alternative embodiment of bridge faucet with side spray kit shown exploded, constructed in accordance with the present invention;

FIG. 13 is a perspective view of the alternative embodiment of the bridge faucet of FIG. 12 with a mixing body cap fastened to the bridge faucet; and

FIG. 14 is a perspective view of the alternative embodiment of the bridge faucet of FIG. 12 and a side spray of the side spray kit with a coupling of the side spray kit fastened to the bridge faucet.

### DESCRIPTION

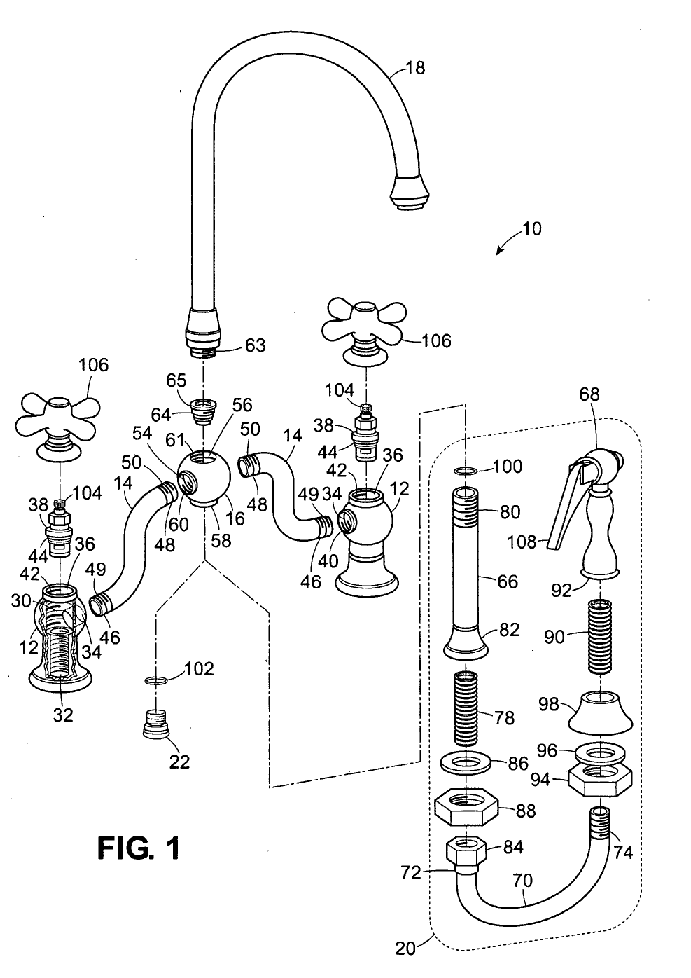

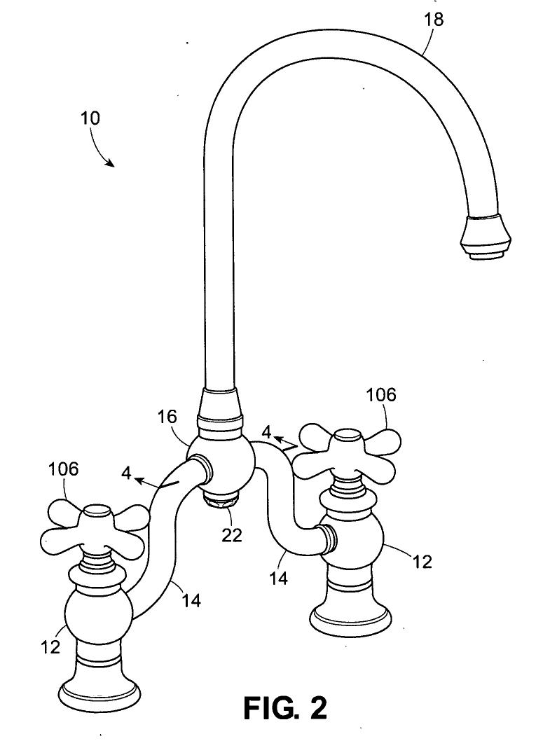

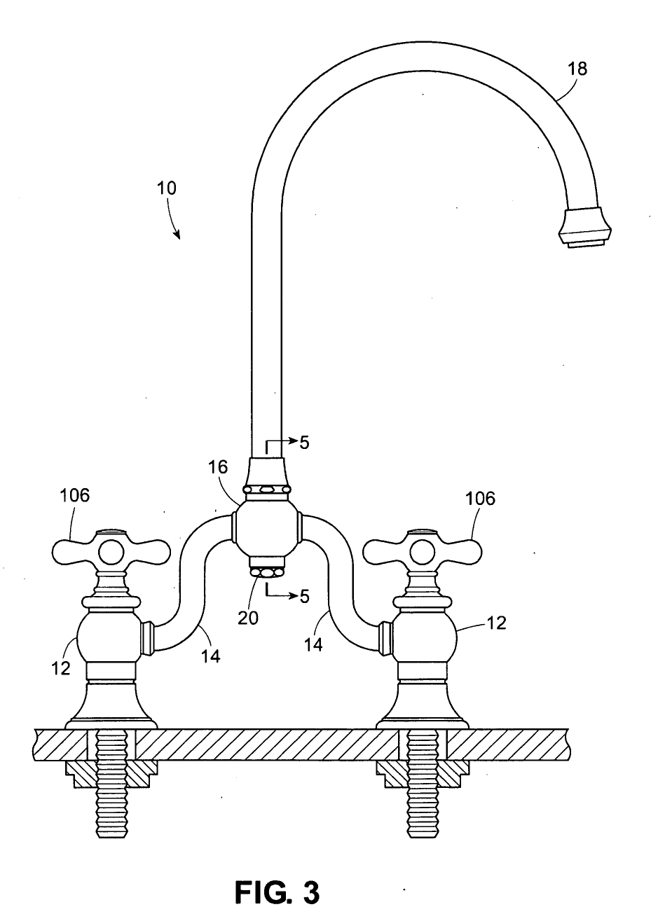

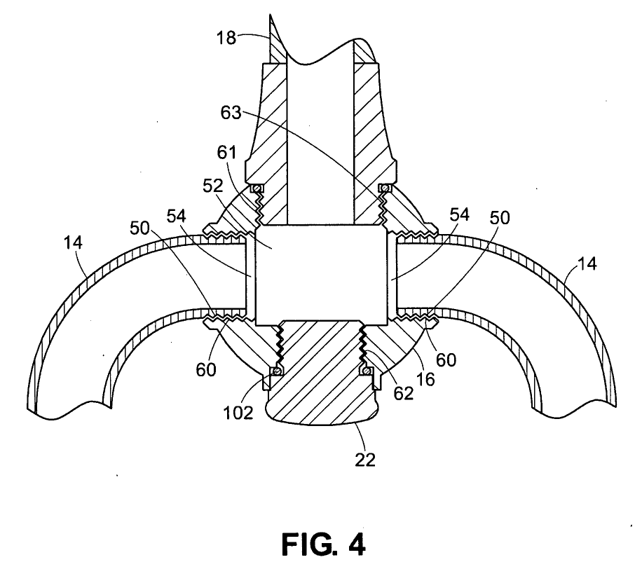

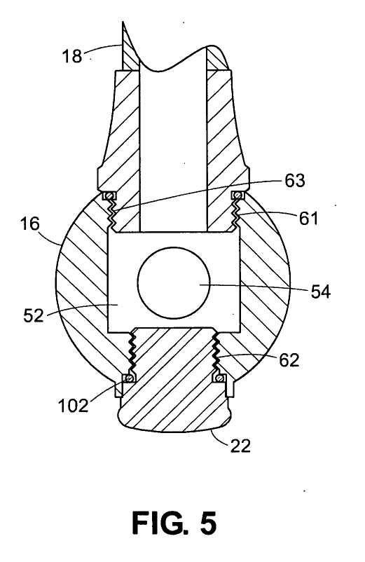

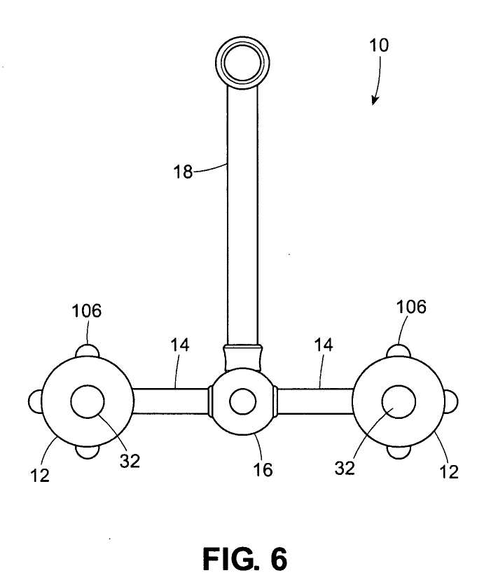

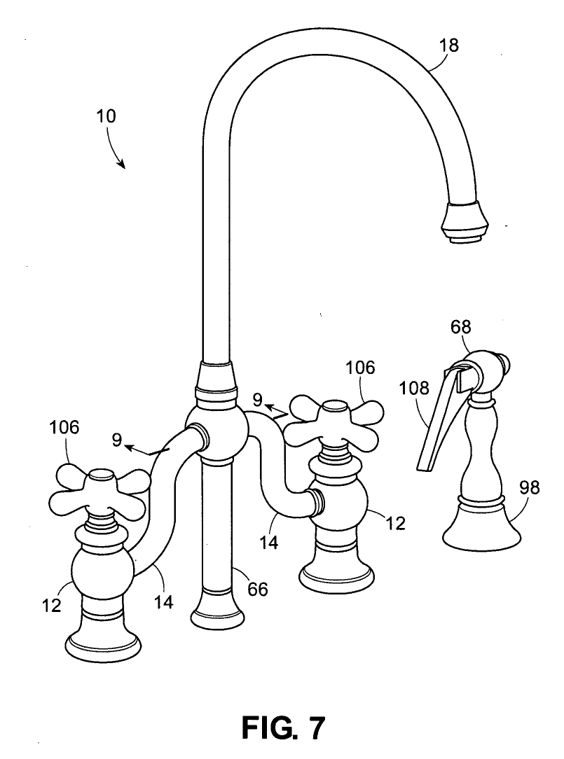

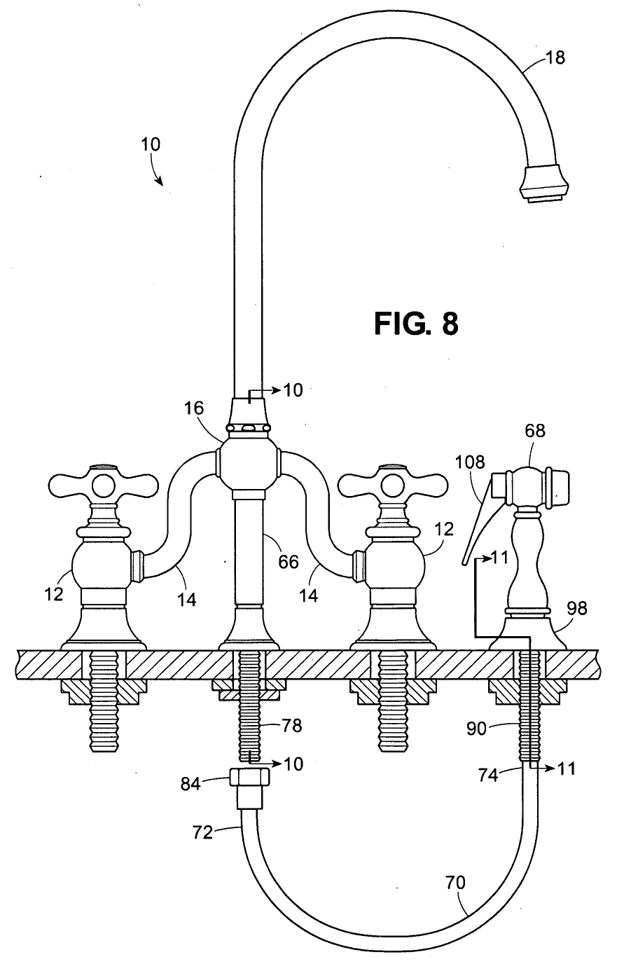

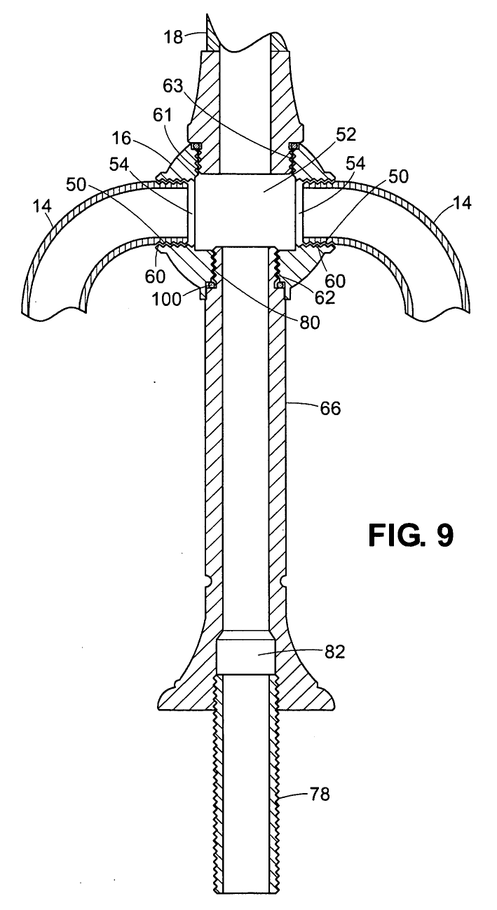

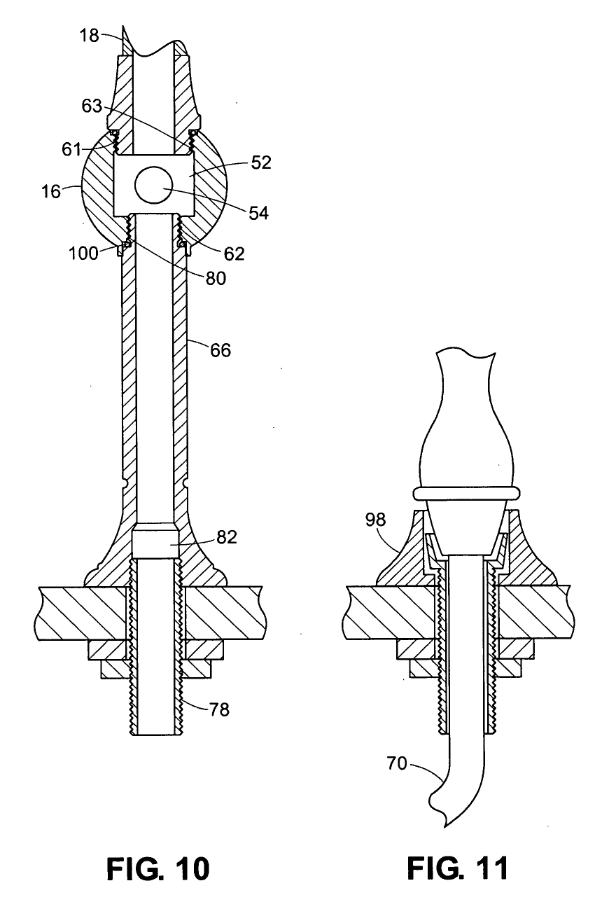

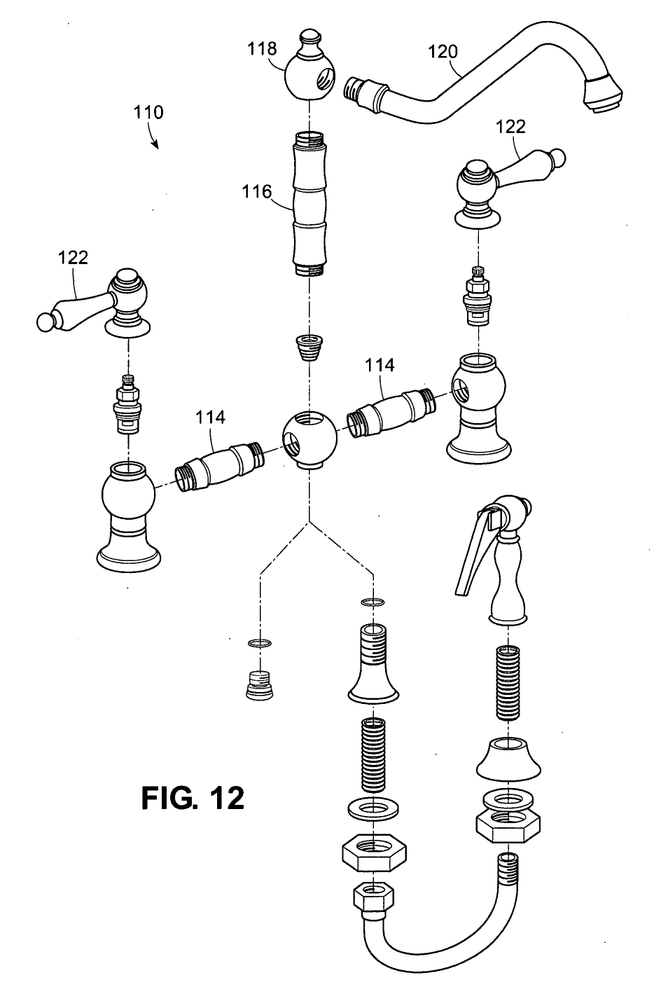

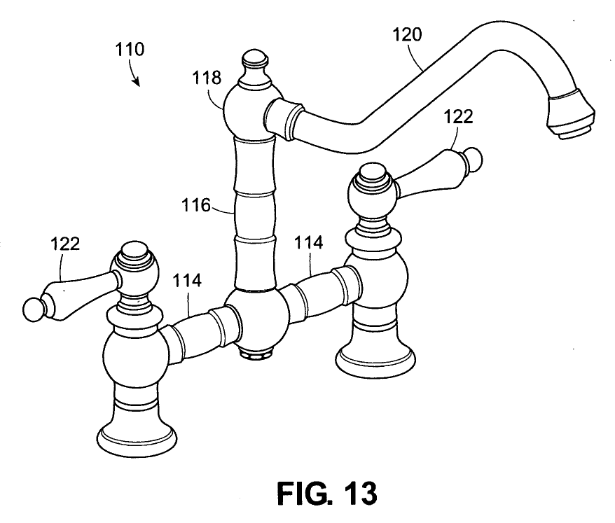

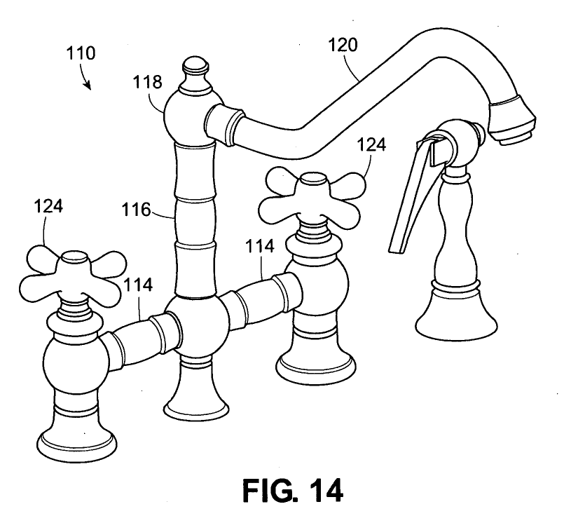

The preferred embodiments of the present invention will be described with reference to FIGS. 1-14 of the drawings. Identical elements in the various figures are identified with the same reference numbers.

FIGS. 1-11 show an embodiment of the present invention, a bridge faucet with side spray kit 10, constructed in accordance with the present invention, comprising opposing valve bodies 12, opposing conduits 14 matingly and releasably fastened to the opposing valve bodies 12, a substantially centrally disposed mixing body 16 matingly and releasably fastened to the opposing valve bodies 12, a spout 18 matingly and releasably fastened to the substantially centrally disposed mixing body 16, a side spray kit 20, and a mixing body cap 22.

The side spray kit 20 and the mixing body cap 22 may selectively and alternatively be releasably fastened to the substantially centrally disposed mixing body 16.

Each valve body 12 of the opposing valve bodies 12 has a valve body chamber 30, a valve body inlet 32 communicating with the valve body chamber 30, a valve body outlet 34 communicating with the valve body chamber 30, a valve body bore 36 communicating with the valve body chamber 30, and a valve body cartridge valve 38 adapted to matingly and removably fit into the valve body chamber 30 through the valve body bore 36.

The valve body cartridge valve 38 is adapted to control flow of fluid between the valve body inlet 32 and the valve body outlet 34.

The valve body outlet 34 has a valve body outlet threaded portion 40, the valve body bore 36 has a valve body bore threaded portion 42, and the valve body cartridge valve 38 has a valve body cartridge valve threaded portion 44. The valve body cartridge valve threaded portion 44 is matingly and releasably fastened to the valve body bore threaded portion 42.

Each conduit 14 of the opposing conduits 14 has a conduit inlet end 46 and a conduit outlet end 48. The conduit inlet end 46 has a conduit inlet threaded portion 49 matingly and releasably fastened to an opposing one of the valve body outlet threaded portions 40 of the opposing valve bodies 12. The conduit outlet end 48 has a conduit outlet threaded portion 50.

The substantially centrally disposed mixing body 16 has a mixing body chamber 52, opposing mixing body inlets 54 communicating with the mixing body chamber 52, a mixing body spout outlet 56 communicating with the mixing body chamber 52, and a mixing body side spray outlet 58 communicating with the mixing body chamber 52.

Each mixing body inlet 54 of the mixing body inlets 54 has a mixing body inlet threaded portion 60 matingly and releasably fastened to one of the conduit outlet threaded portions 50 of the opposing conduits 14.

The mixing body spout outlet 56 has mixing body spout outlet threaded portion 61. The spout 18 has spout threaded portion 63 that is adapted to be matingly and releasably fastened to the mixing body spout outlet threaded portion 61, although other suitable coupling means may be used.

The mixing body side spray outlet 58 has a mixing body side spray outlet threaded portion 62.

The substantially centrally disposed mixing body 16 has a mixing body diverter cartridge 64, which is adapted to matingly and removably fit into the mixing body chamber 52 through the mixing body spout outlet 56.

The mixing body diverter cartridge 64 typically has mixing body diverter cartridge threaded portion 65, which is adapted to be matingly and releasably fastened to the mixing body spout outlet threaded portion 61, although other suitable coupling means may be used.

Both the mixing body diverter cartridge threaded portion 65 of the mixing body diverter cartridge 64 and the mixing body spout outlet threaded portion 61 of the spout 18 are matingly and removably fastened to the substantially centrally disposed mixing body 16 at the mixing body spout outlet threaded portion 61.

Again, the side spray kit 20 and the mixing body cap 22 may alternatively be releasably fastened to the substantially centrally disposed mixing body 16.

The side spray kit 20 has a side spray kit threaded coupling 66 that is adapted to matingly and releasably fasten to the mixing body side spray outlet threaded portion 62, a side spray valve 68, and a flexible conduit 70 that has a flexible conduit inlet end 72 and a flexible conduit outlet end 74. The flexible conduit inlet end 72 is coupled to the side spray kit threaded coupling 66, and the side spray valve 68 is coupled to the flexible conduit outlet end 74. The side spray valve 68 is adapted to control flow of the fluid received from the substantially centrally disposed mixing body 16 via the flexible conduit 70.

The mixing body diverter cartridge 64 is adapted to mix the fluid received within the mixing body chamber 52 from the opposing valve bodies 12 via the opposing conduits 14.

The mixing body diverter cartridge 64 is also adapted to divert the fluid received within the mixing body chamber 52 from the opposing valve bodies 12 via the opposing conduits 14 and prevent the fluid from flowing into the spout 18 when the side spray kit threaded coupling 66 is matingly and releasably fastened to the mixing body side spray outlet threaded portion 62 and when the side spray valve 68 is turned on.

The mixing body diverter cartridge 64 is also adapted to direct the fluid received within the mixing body chamber 52 from the opposing valve bodies 12 via the opposing conduits 14 into the spout 18 when the side spray kit threaded coupling 66 is matingly and releasably fastened to the mixing body side spray outlet threaded portion 62 and when the side spray valve 68 is turned off.

The mixing body cap 22 is adapted to matingly and releasably fasten to the mixing body side spray outlet threaded portion 62 when the side spray kit threaded coupling 66 is removed from the mixing body side spray outlet threaded portion 62.

The mixing body diverter cartridge 64 is also adapted to direct the fluid received within the mixing body chamber 52 from the opposing valve bodies 12 via the opposing conduits 14 into the spout 18 when the mixing body cap 22 is matingly and releasably fastened to the mixing body side spray outlet threaded portion 62. The spout 18 may be fixed in place or the spout 18 may swivel.

The side spray kit threaded coupling 66 has a first threaded end 80 that is adapted to matingly and releasably fasten to the mixing body side spray outlet threaded portion 62 and an opposing second threaded end 82 that is adapted to matingly and releasably fasten to threaded nipple 78, although another suitable coupling may be used. The flexible conduit inlet end 72 has a threaded fitting 84 that is adapted to matingly and releasably fasten to the threaded nipple 78. O ring 86 is used to seal the threaded nipple 78 and the threaded fitting 84. Removably releasable threaded fastener 88 is used to tighten the threaded fitting 84 to the threaded nipple 78.

The side spray valve 68 is coupled to the flexible conduit outlet end 74 with another threaded nipple 90, although another suitable coupling may be used. The side spray valve 68 has a threaded fitting 92 that is adapted to matingly and releasably fasten to the other threaded nipple 90. Removably releasable threaded fastener 94 is used to releasably and matingly fasten the flexible conduit outlet end 74 and the other threaded nipple 90 one to the other. Other O ring 96 is used to seal the flexible conduit outlet end 74 and the other threaded nipple 90. Escutcheon 98 is also used.

Other O rings 100 and 102 are used to alternatively seal the first threaded end 80 or the mixing body cap 22 to the mixing body side spray outlet threaded portion 62.

The valve body cartridge valves 38 have stems 104 for manually controlling the flow of fluid through the opposing valve bodies 12. The stems 104 may be grooved for matingly and releasably receiving handles 106 or other suitable handles that are adapted to matingly and releasably fit on the stems 104.

The side spray kit 20 has actuator 108 for manually controlling flow of fluid from the side spray kit 20.

The threaded portions, fasteners, and the like of the bridge faucet with side spray kit 10 may be sealed with suitable sealers, adhesives, O rings, washers, and any combination thereof.

The bridge faucet with side spray kit 10 may be of metal, such as brass, copper, aluminum, stainless steel, thermoplastics, thermosetting polymers, rubber, or other suitable material and any combination thereof.

FIGS. 12-14 show an alternate embodiment of the present invention, a bridge faucet with side spray kit 110, constructed in accordance with the present invention, which is substantially the same as the bridge faucet with side spray kit 10, except that the bridge faucet with side spray kit 110 has substantially straight opposing conduits 114, substantially straight spout riser 116, spout coupling 118, and spout extension 120. The spout coupling 118 is adapted to be matingly and releasably fastened to the substantially straight spout riser 116 and the spout extension 120. The bridge faucet with side spray kit 110 is shown with alternate handles 122 and 124.

Although the present invention has been described in considerable detail with reference to certain preferred versions thereof, other versions are possible. Therefore, the spirit and scope of the appended claims should not be limited to the description of the preferred versions contained herein.

What is claimed is:

1. A bridge faucet with side spray kit, comprising:
opposing valve bodies,
each valve body of said opposing valve bodies having:
a valve body chamber,
a valve body inlet communicating with said valve body chamber,
a valve body outlet communicating with said valve body chamber,
a valve body bore communicating with said valve body chamber,
a valve body cartridge valve,
said valve body cartridge valve adapted to matingly and removably fit into
said valve body chamber through said valve body bore,
said valve body cartridge valve adapted to control flow of fluid between
said valve body inlet and said valve body outlet;
opposing conduits,
each conduit of said opposing conduits having:
a conduit inlet end matingly and releasably fastened to a said valve body outlet,
a conduit outlet;
a substantially centrally disposed mixing body having:
a mixing body chamber,
opposing mixing body inlets communicating with said mixing body chamber,
each mixing body inlet of said opposing mixing body inlets matingly and releasably fastened to a said conduit outlet,
a mixing body spout outlet communicating with said mixing body chamber,
a mixing body side spray outlet communicating with said mixing body chamber,
a mixing body diverter cartridge,
said mixing body diverter cartridge adapted to matingly and removably fit into said mixing body chamber through said mixing body spout outlet,
said mixing body diverter cartridge adapted to mix said fluid received within said mixing body chamber from said opposing valve bodies via said opposing conduits;
a spout,
said spout matingly and releasably fastened to said mixing body spout outlet,
a side spray kit,
said side spray kit having a side spray kit coupling adapted to matingly and releasably fasten to said mixing body side spray outlet,
a flexible conduit having a flexible conduit inlet end and a flexible conduit outlet end,
said flexible conduit inlet end coupled to said side spray kit coupling,
a side spray valve,
said side spray valve coupled to said flexible conduit outlet end,
said side spray valve adapted to control flow of said fluid received from said substantially centrally disposed mixing body via said flexible conduit;
said mixing body diverter cartridge adapted to divert said fluid received within said mixing body chamber from said opposing valve bodies via said opposing conduits and prevent said fluid from flowing into said spout when said side spray kit coupling is matingly and releasably fastened to said mixing body side spray outlet and when said side spray valve is turned on;
a mixing body cap adapted to matingly and releasably fasten to said mixing body side spray outlet when said side spray kit coupling is removed from said mixing body side spray outlet.

2. The bridge faucet with side spray kit according to claim 1, wherein:
said mixing body diverter cartridge is adapted to direct said fluid received within said mixing body chamber from said opposing valve bodies via said opposing conduits into said spout when said side spray kit coupling is matingly and releasably fastened to said mixing body side spray outlet and when said side spray valve is turned off.

3. The bridge faucet with side spray kit according to claim 1, wherein:
said mixing body diverter cartridge is adapted to direct said fluid received within said mixing body chamber from said opposing valve bodies via said opposing conduits into said spout when said mixing body cap is matingly and releasably fastened to said mixing body side spray outlet.

4. A bridge faucet with side spray kit, comprising:
opposing valve bodies,
each valve body of said opposing valve bodies having:
a valve body chamber,
a valve body inlet communicating with said valve body chamber,
a valve body outlet communicating with said valve body chamber,
said valve body outlet having a valve body outlet threaded portion,
a valve body bore communicating with said valve body chamber,
said valve body bore having a valve body bore threaded portion,
a valve body cartridge valve,
said valve body cartridge valve adapted to matingly and removably fit into said valve body chamber through said valve body bore,
said valve body cartridge valve adapted to control flow of fluid between said valve body inlet and said valve body outlet,
said valve body cartridge valve having a valve body cartridge valve threaded portion,
said valve body cartridge valve threaded portion matingly and releasably fastened to said valve body bore threaded portion;
opposing conduits,
each conduit of said opposing conduits having:
a conduit inlet end having a conduit inlet threaded portion matingly and releasably fastened to a said valve body outlet threaded portion, a conduit outlet end having a conduit outlet threaded portion;
a substantially centrally disposed mixing body having:
a mixing body chamber,
opposing mixing body inlets communicating with said mixing body chamber,
each mixing body inlet of said opposing mixing body inlets having a mixing body inlet threaded portion matingly and releasably fastened to a said conduit outlet threaded portion,
a mixing body spout outlet communicating with said mixing body chamber,
a mixing body side spray outlet communicating with said mixing body chamber,
said mixing body side spray outlet having a mixing body side spray outlet threaded portion,
a mixing body diverter cartridge,
said mixing body diverter cartridge adapted to matingly and removably fit into said mixing body chamber through said mixing body spout outlet,
said mixing body diverter cartridge adapted to mix said fluid received within said mixing body chamber from said opposing valve bodies via said opposing conduits;
a spout,
said spout matingly and releasably fastened to said mixing body spout outlet,
a side spray kit,
said side spray kit having a side spray kit threaded coupling adapted to matingly and releasably fasten to said mixing body side spray outlet threaded portion,
a flexible conduit having a flexible conduit inlet end and a flexible conduit outlet end,
said flexible conduit inlet end coupled to said side spray kit threaded coupling,
a side spray valve,
said side spray valve coupled to said flexible conduit outlet end,
said side spray valve adapted to control flow of said fluid received from said substantially centrally disposed mixing body via said flexible conduit;
said mixing body diverter cartridge adapted to divert said fluid received within said mixing body chamber from said opposing valve bodies via said opposing conduits and prevent said fluid from flowing into said spout when said side spray kit threaded coupling is matingly and releasably fastened to said mixing body side spray outlet threaded portion and when said side spray valve is turned on;
a mixing body cap adapted to matingly and releasably fasten to said mixing body side spray outlet threaded portion when said side spray kit threaded coupling is removed from said mixing body side spray outlet threaded portion.

5. The bridge faucet with side spray kit according to claim 4, wherein:
said mixing body diverter cartridge is adapted to direct said fluid received within said mixing body chamber from said opposing valve bodies via said opposing conduits into said spout when said side spray kit threaded coupling is matingly and releasably fastened to said mixing body side spray outlet threaded portion and when said side spray valve is turned off.

6. The bridge faucet with side spray kit according to claim 4, wherein:
said mixing body diverter cartridge is adapted to direct said fluid received within said mixing body chamber from said opposing valve bodies via said opposing conduits into said spout when said mixing body cap is matingly and releasably fastened to said mixing body side spray outlet threaded portion.
